(19) United States
(12) Patent Application Publication
(10) Pub. No.: US 2006/0003262 A1
(43) Pub. Date: Jan. 5, 2006

(54) Forming electrical conductors on a substrate

(75) Inventors: Zhihao Yang, Webster, NY (US); David B. Kay, Rochester, NY (US); Lee W. Tutt, Webster, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/881,301

(22) Filed: Jun. 30, 2004

(51) Int. Cl. G03C 5/00; B44C 1/22

(52) U.S. Cl. 430/311; 118/620; 216/83

(57) ABSTRACT

A method of forming a pattern of electrical conductors on a substrate (18) consists of forming metal nanoparticles on a conductive material. A light absorbing dye is mixed with the metal nanoparticles. The mixture is then coated on the substrate. The pattern is formed on the coated substrate with laser light (14). Unannealed material is removed from the substrate.

### FIELD OF THE INVENTION

The invention relates in general to forming a pattern of conductors on a substrate and in particular to forming conductors on a substrate by selectively annealing a mixture of laser light absorbing dyes and metal nanoparticles.

### BACKGROUND OF THE INVENTION

It is often necessary to print large area electrical circuits with conductors having at least one lateral dimension of 1-1000 microns. One process for accomplishing this type of circuit printing is using vacuum deposition. This method, however, is a high-cost operation and is only suitable for batch processing.

Another method of constructing electrical circuits is inkjet printing of patterns using metal nanoparticles to form conductors. This process is discussed in S. Molesa et al.; “High-quality inkjet-printed multilevel interconnects and inductive components on plastic for ultra-low-cost RFID applications.” University of California, Berkeley. Some problems associated with this technique are that it is substrate dependent, it is difficult to achieve lateral dimensions of less than 100 microns, and the particles must be annealed by bulk heating, which can cause substrate deformation. Another problem with inkjet deposition is that it often requires multiple passes to deposit the proper amount of material, which reduces throughput.

Attempts to solve the bulk-heating problem, shown in the following two references, involve using high-powered lasers to anneal nanoparticles. N. R. Bieri et al.; “Microstructuring by printing and laser curing of nanoparticle solutions” Applied Physics Letters, Volume 82, Number 20, May 19, 2003, pages 3529-3531; and J. Chung et al.; “Conductor microstructures by laser curing of printed gold nanoparticle ink” Applied Physics Letters, Volume 84, Number 5, Feb. 2, 2004, pages 801-803. Gold nanoparticles, which are used as an example, have low absorption in the visible spectrum resulting in low heating efficiency. This low heating efficiency is a problem in commercial applications because of low writing speeds.

### SUMMARY OF THE INVENTION

Briefly, according to one embodiment of the present invention a method of forming a pattern of electrical conductors on a substrate consists of forming metal nanoparticles on a conductive material. A light absorbing dye is mixed with the metal nanoparticles. The mixture is then coated on the substrate. The pattern is formed on the coated substrate with laser light. Unannealed material is removed from the substrate.

Solution processable metal nanoclusters were formulated with light absorbing dyes in a solvent. The material was coated on a plastics substrate as a thin film. A laser was used to write on the surface and convert the metal nanoclusters to sintered and conducting metal thin films with desired patterns.

The invention and its objects and advantages will become more apparent in the detailed description of the preferred embodiment presented below.

### BRIEF DESCRIPTION OF THE DRAWINGS

FIG. 1 shows a schematic drawing of an apparatus that is useful for annealing a nanoparticle layer on a substrate.

FIG. 2 shows a cross section with a thin layer of nanoparticles.

FIG. 3 shows a cross section of a substrate with a portion of the nanoparticle layer annealed.

FIG. 4 shows a cross section of a substrate with the unannealed portions of the nanoparticle layer removed.

FIG. 5 shows a schematic of an alternate printhead for use with the present invention.

FIG. 6 shows a schematic of an alternate printhead for use with the present invention.

FIG. 7 shows a schematic of an alternate printhead for use with the present invention.

### DETAILED DESCRIPTION OF THE INVENTION

One of most characteristic feature of metal nanoparticles is the size-dependent surface melting point depression. (Ph. Buffat et al.; “Size effect on the melting temperature of gold particles” Physical Review A, Volume 13, Number 6, June 1976, pages 2287-2297; A. N. Goldstein et al.; “Melting in Semiconductor Nanocrystals” Science, Volume 256, Jun. 5, 1992, pages 1425-1427; and K. K. Nanda et al.; “Liquid-drop model for the size-dependent melting of low-dimensional systems” Physical Review, A 66 (2002), pages 013208-1 thru 013208-8.) This property would enable the melting or sintering of the metal nanoparticles into polycrystalline films with good electric conductivity. (D. Huang, et al.; “Plastic-Compatible Low Resistance Printable Gold Nanoparticle Conductors for Flexible Electronic” Journal of the Electrochemical Society, Volume 150, Issue 7, July 2003, Abstract.) The present invention will be directed to a method of forming a pattern of electrical conductors on a substrate by using a laser to write the pattern on a recording element consisting of a thin film of metal nanoparticles coated on the support substrate. In general, a light absorbing dye is mixed with the metal nanoparticles. The mixture is then coated on the substrate. The pattern is formed on the coated substrate with laser light. Unannealed material is removed from the substrate. In a preferred embodiment, solution processable metal nanoclusters were formulated with light absorbing dyes in a solvent. The material was coated on a plastics substrate as a thin film. A laser was used to write on the surface and convert the metal nanoclusters to sintered and conducting metal thin films with desired patterns.

The present invention will be directed in particular to elements forming part of, or in cooperation more directly with the apparatus in accordance with the present invention. It is to be understood that elements not specifically shown or described may take various forms well known to those skilled in the art.

To obtain a laser-annealed conductive material image using the process of the invention, a diode laser is preferably employed since it offers substantial advantages in terms of its small size, low cost, stability, reliability, ruggedness, and ease of modulation. In practice, before any laser can be used to heat the coated element, the element must contain an infrared-absorbing material, such as pigments like carbon black, or cyanine infrared-absorbing dyes as described in U.S. Pat. No. 4,973,572, or other materials as described in the following U.S. Pat. Nos. 4,948,777; 4,950,640; 4,950,639; 4,948,776; 4,942,141; 4,952,552; 5,036,040; and 4,912,083, the disclosures of which are hereby incorporated by reference. The laser radiation is then absorbed into the dye and converted to heat by a molecular process known as internal conversion. Thus, the construction of a useful dye will depend not only on the hue, transferability and intensity of the dye, but also on the ability of the dye to absorb the radiation and convert it to heat. The infrared-absorbing material or dye may be contained in the metal nanoparticle coating itself or in a separate layer associated therewith, i.e., above or below the dye layer.

The active layer of element employed in the invention may be coated on the support or printed thereon by any solvent compatible printing technique such as a inkjet, gravure process, hopper coating or other methods known in the art.

Any material can be used as the substrate 18 for the element of the invention, provided it can withstand the heat of the laser. Such materials include polyesters such as poly(ethylene naphthalate); poly(ethylene terephthalate); polyamides; polycarbonates; cellulose esters such as cellulose acetate; fluorine polymers such as poly(vinylidene fluoride) or poly(tetrafluoroethylene-co-hexafluoropropylene); polyethers such as polyoxymethylene; polyacetals; polyolefins such as polystyrene, polyethylene, polypropylene or methylpentene polymers; and polyimides such as polyimide-amides and polyether-imides. Metal substrates and inorganic materials such as glasses, silicon germanium and metal oxides such as aluminum oxide and silicon oxide are also useful for this invention. The substrate can also comprise two or more layers of these materials. The substrate generally has a thickness of from about 5 to about 5000 μm.

The metal nanoclusters can be silver, gold, or alloys of metals, other noble metals mixtures such that they can be formed into stable nano clusters. The sizes of the nanoclusters are typically in the range of 1 to 10 nanometers.

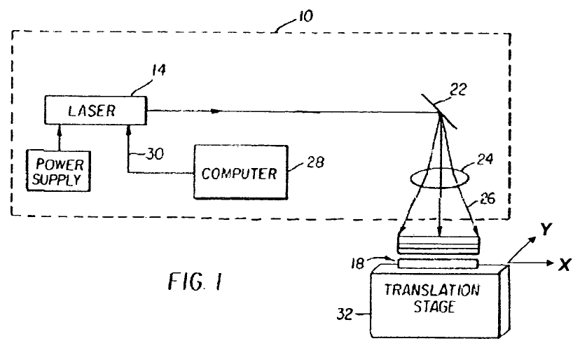

Referring now to FIG. 1 there is shown a laser printing apparatus 10 for exposing the substrate 18 imagewise to the laser radiation in accordance with the present invention. The laser 14 of the printing apparatus 10 can be a diode laser or any other high power laser that produces a laser beam 26. More than one laser or laser beam can be used simultaneously in this invention. The beam shape may be oval to allow small lines to be written while using low cost multimode laser, as taught in commonly-assigned U.S. Pat. No. 6,252,621, the disclosure of which is hereby incorporated by reference. In order to scan the laser beam to provide relative movement between laser beam 26 and substrate 18, a galvanometer 22 that includes a moveable mirror scans the beam through an f-theta lens 24 to form a line in direction X. Those skilled in the art will understand that scanning the laser beam can also be accomplished by other kinds of moveable mirrors, such as rotating polygons with mirror faces, or by other devices such as rotating diffraction gratings.

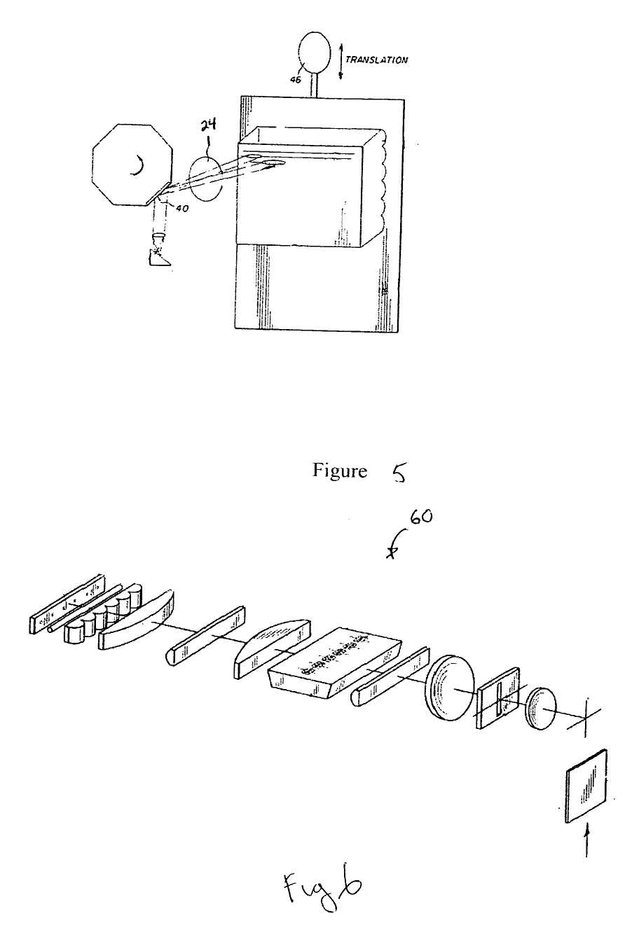

There are various laser thermal printers that can be used to write the image into the nanoparticle coating. The deflector in the scanner could be a rotating polygon deflector 40 like that used in U.S. Pat. No. 6,031,561. Only a single laser source, not shown, would normally be used as polygons rotate many thousands of revolutions per minute and the printing rate is quite fast compared to the previous galvo-scanner. Polygon scanners usually employ an f-theta lens 24 in FIG. 5, that focuses the scanned laser beam onto the receiver surface. Again, the laser source is modulated (or a continuous laser beam can be modulated by a separate modulator, i.e. a acoustic-optic modulator) with image data supplied by an appropriate digital electronics data path. The laser spot is scanned by the polygon deflector in the fast scan direction, while the receiving surface is scanned in the slow scan direction by linear translator 46 of FIG. 5. The laser beam must have sufficient power to heat the nanoparticle coating to a temperature high enough to cause sintering of the nanoparticles. The scanned spot size mostly determines the resolution of the printed line. Conducting lines, or pads, or any image feature can be printed as sintered nanoparticles.

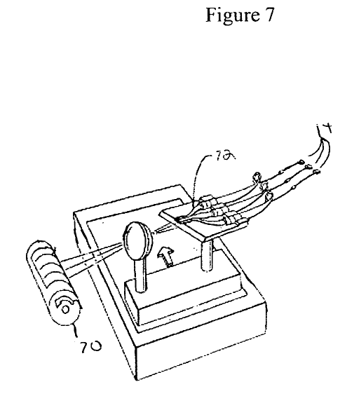

Another printer that would be useful for performing the laser patterning process uses a multichannel printhead 60, like the one shown in FIG. 6 and in U.S. Pat. No. 6,169,565, but suitable folded into a reasonably compact multichannel printhead. The printhead is scanned back and forth in the fast direction at constant velocity (except at the turn around times), and the receiver is advanced by the width of the array of the 256 printing spots after each scan of the printhead. Alternately, the head could print to a receiver sheet that is mounted onto a rotating drum 70 as shown in FIG. 7 discussed in U.S. Pat. No. 4,900,130. The printhead in U.S. Pat. No. 4,900,130 is made with lasers 14 attached to the ends of the fibers 72 being imaged to an array of printing spots at the receiver. This is yet another printhead suitable to the task.

In the embodiment shown in FIG. 1, substrate 18 is transported in a direction Y, which is orthogonal to the line, by a translation stage 32 allowing the full area to be scanned. The intensity of the beam at any point in the scan is controlled by the laser power control line 30 using instructions from the computer 28. Alternatively, the intensity of the laser beam can be controlled by a separate modulator such as an acoustooptic modulator (not shown), as is well known by those skilled in the art of laser optics. In an alternative embodiment, the substrate can remain stationary and the laser apparatus is made to move or its beam redirected optically. The important feature is that there is relative movement between the laser beam and the display substrate in order to allow full area scanning.

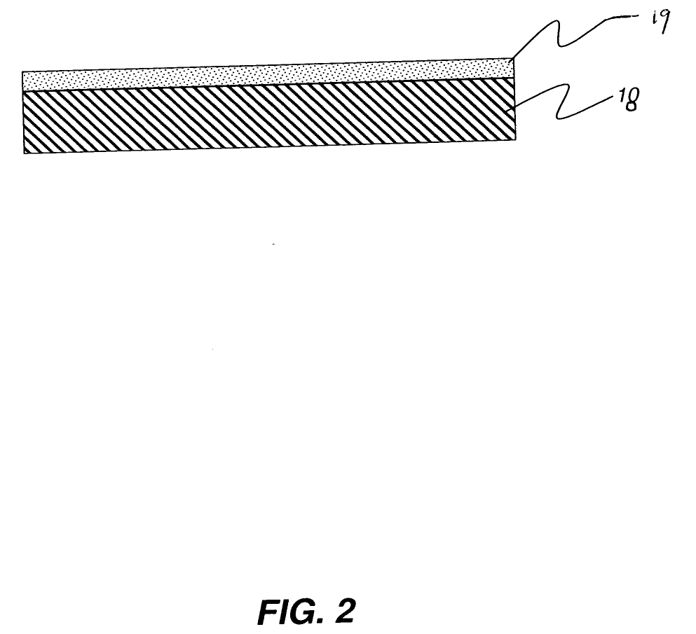

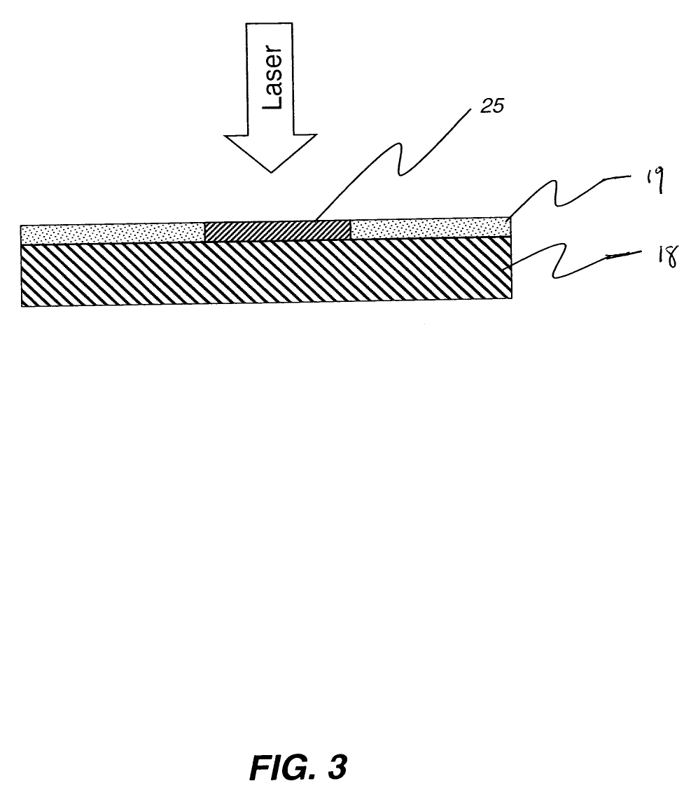

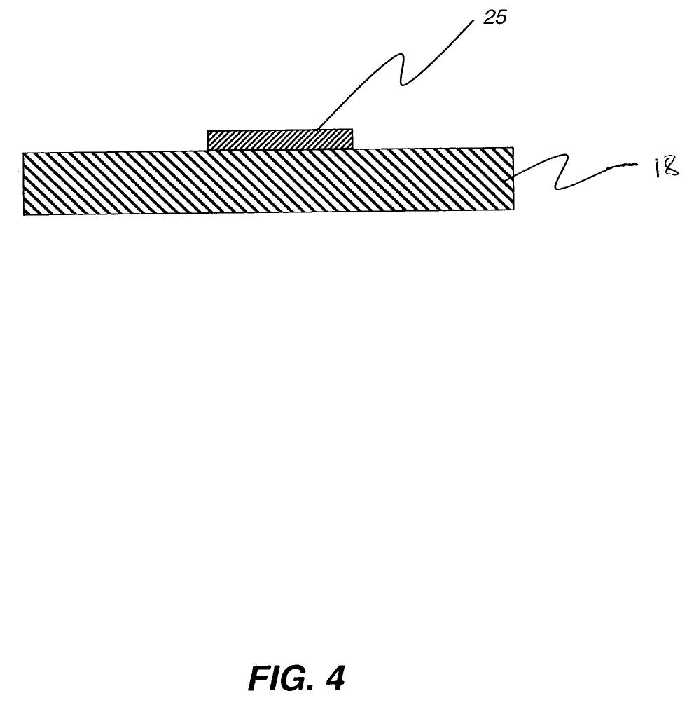

The process is shown in FIGS. 2-4: (i) the metal nanoparticles with diameter less 10 nm, preferably less than 5 nm are synthesized; (ii) a thin film coating 19 on a support substrate 18 is made from a solution comprising the metal nanoparticles having a concentrate of from 1% to 80%, preferably form 10% to 40% and at least one light absorbing dye having a concentrate of from 0.1% to 20%, preferably form 1% to 5%; (iii) a laser beam 26 is used to write on the coated substrate with a pattern and convert or anneal the nanoparticle coating to a metallic conductive film 25; and (iv) remove the unannealed nanoparticles by solvent wash and the patterned conductive metal film retains on the support.

Referring again to FIGS. 2-4 a beam is shown as two spaced arrows. For convenience of illustration, it will be understood that the laser beam has actually been moved between two different positions where it is turned on for annealing portions of the layer 19.

In a preferred embodiment, the beam is continuously scanned by the galvanometer 22 across the support substrate 18 while the laser power is modulated by instructions from the computer 28. The modulation of laser power incident on the support substrate 18 causes thermal conversion of the material in the coated layer 19 in selected regions of the scan to display substrate 18. In a preferred embodiment, the material of coated layer 19 is converted to a metallic conductive film 25. Examples:

The synthesis of Au nanoparticles was conducted by the following procedure. Fourteen grams of tetraoctyl ammonium bromide were dissolved in 400 ml of toluene and 3.0 grams of hydrogen tetrachloroaurate (HAuCl₄) were dissolved in 100 ml of water. Pour the tetrachloroaurate/water mixture into a flask that contains the tetraoctyl ammonium bromide/toluene. Cap and shake the flask for a few seconds. Pour the mixture into a separatory funnel, allow the water/toluene layers to separate, and then collect the top layer (toluene) solution. Take the reddish brown organic phase and put it back into a round bottom flask. Add a solution of 4.7 grams of hexanethiol in 25 ml of toluene to the flask and stir for 10 minutes until the solution becomes colorless. Dissolve 3.8 grams of sodium borohydride into 175 ml of water. While vigorous stirring, add the NaBH4 solution to the organic phase over two minutes using a dropping funnel. Let stir for 3.5 hours and collect materials from the organic phase using a separatory funnel. Solvent was removed by Roto-evaporation (keep temperature less than 50C). Add 100 ml of ethanol to the round bottom flask with product, and sonicate mixture for 2 minutes. Filter this material using a fine fritted glass filter, and wash precipitate with 100 ml of ethanol. The product (gold nanoparticles) was dried in a vacuum oven with no heat for an hour and measured to be 0.8 to 1 grams. The nanoparticles have the size of 2-4 nm examined by TEM, and show a melting or sintering temperature of 190-200C by DSC.
The coating solution was formulated using the following recipes:
   Solution 1: 10% Au nanoparticles and 1% IR Dye 1 were dissolved in a 40/60 mixed solvent of ethanol/toluene.
   Solution 2: 20% Au nanoparticles and 2% IR dye 1 were dissolved in a 40/60 mixed solvent of ethanol/toluene.
   Control Solution: 10% Au nanoparticles were dissolved in a 40/60 mixed solvent of ethanol/toluene. 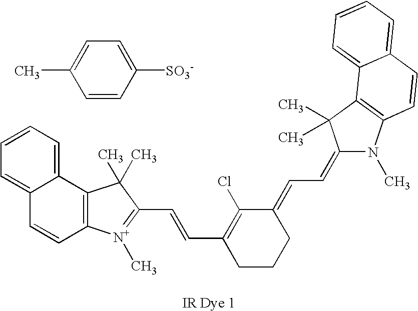
      The solutions were coating on 4 mil PET substrates by either hand coating with coating blades or coating rods, or by machine coating through a hopper. The wet lay-down of coatings was calculated ranging from 5 um to 25 um. The final dry thicknesses of coating were measured ranging from 0.15 um to 2 um.

A laser writer containing a laser diode at 830 nm and max power of 600 mW was used to anneal the coated nanoparticles and write patterns by scanning through the substrates according to predetermined images. The scanning speed was set as such that the laser exposure on the coated substrate at the energy level about 2 J/cm2. The laser exposed region turned to the golden metallic color. The unexposed nanoparticles can be removed from PET substrates by dipping in ethanol and toluene.

The results of laser annealed and patterned Au conductors on PET substrate are shown in the Table 1.

TABLE 1

| Coating | Wet Lay-down | Dry Thickness | Resistivity (Ohm- |
|---|---|---|---|
| Solution | (um) | (um) | m) |
| Solution 1 | 12 | 0.5 | 2.3 × 10⁻⁶ |
| Solution 2 | 5 | 0.15 | 3.8 × 10⁻⁷ |
| Solution 2 | 12 | 1 | 1.7 × 10⁻⁶ |
| Solution 2 | 25 | 2 | 2.1 × 10⁻⁶ |
| Control | 12 | 0.5 | Infinity |

Table 1 shows that upon laser annealing the resistivity drops to a very conductive state. The control remains nonconductive due to the lack of sintering.

The unannealed (unexposed to the laser regions) may be removed by a solvent wash, allowing recovery and reuse. Due to the unexposed nanocluster's high resistivity, it may be desirable to save a processing step let them remain in place without sacrificing functionality.

The invention has been described in detail with particular reference to certain preferred embodiments thereof, but it will be understood that variations and modifications can be effected within the scope of the invention.

### Parts List

10 laser printing apparatus
14 laser
18 substrate
19 thin film coating
22 galvanometer
24 f-theta lens
25 metallic conductive film
26 laser beam
28 computer
30 laser power control line
32 translation stage
40 polygon
46 linear translator
60 multichannel printhead
70 rotating drum
72 fibers

1. A method of forming a pattern of electrical conductors on a substrate comprising:
forming metal nanoparticles of a conductive material;
mixing a light absorbing dye with said metal nanoparticles;
coating said mixture on said substrate; and
forming said pattern on said coated substrate with laser light.

2. A method as in claim 1 comprising the additional step of removing unannealed material from said substrate.

3. A method as in claim 1 wherein said substrate is flexible.

4. A method as in claim 1 wherein said nanoparticles are selected from a group comprising gold, silver, palladium, and platinum.

5. A method as in claim 1 wherein said metal nanoparticles have an organic shell.

6. A method as in claim 1 wherein said nanoparticles are less than 10 nm lateral dimension.

7. A method as in claim 1 wherein said nanoparticles are less than 5 nm lateral dimension.

8. A method as in claim 1 wherein said light absorbing dye is an infrared absorbing dye.

9. A method as in claim 1 wherein said laser light is produced by an infrared laser.

10. A method as in claim 1 wherein said laser light is produced by a printhead comprised of a plurality of lasers.

11. A method as in claim 1 wherein said laser light is produced by a multichannel laser printhead.

12. A method as in claim 1 wherein said laser light is produced by a polygon laser scanner.

13. A method as in claim 1 wherein said laser light anneals said nanoparticles.

14. A method as in claim 13 wherein said nanoparticles are annealed at a temperature of less than 500 degrees centigrade.

15. A method as in claim 13 wherein said nanoparticles are annealed any temperature of less than 300 degrees centigrade.

16. A method as in claim 1 wherein said unannealed material is removed by at least one solvent.

17. A method as in claim 16 wherein a first solvent removes said laser light absorbing dye and a second solvent removes unannealed nanoparticles.

18. An apparatus for forming a pattern of electrical conductors on a substrate comprising:
a mixer for combining metal nanoparticles and a light absorbing dye;
a coater for coating said mixture on said substrate;
a laser for forming said pattern on said coated substrate with laser light; and
a solvent bath for removing unannealed material from said substrate.

19. A method of forming a pattern of electrical conductors on a flexible substrate comprising:
mixing a light absorbing dye with conductive nanoparticles;
applying said mixture to said substrate; and
annealing said pattern on said coated substrate with laser light.

20. A method as in claim 19 comprising the additional step of:
removing unannealed material from said substrate.

21. A method as in claim 19 wherein said nanoparticles are selected from a group comprising gold, silver, palladium, and platinum.

22. A method as in claim 19 wherein said metal nanoparticles have an organic shell.

23. A method as in claim 19 wherein said nanoparticles are less than 5 nm lateral dimension.

24. A method as in claim 19 wherein said laser light absorbing dye is an infrared absorbing dye.

25. A method as in claim 19 wherein said laser light is produced by an infrared laser.

26. A method as in claim 19 wherein said nanoparticles are annealed at a temperature of less than 300 degrees centigrade.

27. A method as in claim 19 comprising the additional steps of:
removing said laser light absorbing dye with a first solvent; and
removing unannealed nanoparticles with a second solvent.
